(19) United States
(12) Patent Application Publication
(10) Pub. No.: US 2023/0212328 A1
(43) Pub. Date: Jul. 6, 2023

(54) METHOD FOR PREPARING A CATALYST

(71) Applicants: INEOS EUROPE AG, Rolle, Vaud (CH); CENTRE NATIONAL DE LA RECHERCHE SCIENTIFIQUE, Paris Cedex 16 (FR); THE UNIVERSITE CLAUDE BERNARD LYON 1, Villeurbanne (FR); ECOLE SUPERIEURE DE CHIMIE-PHYSIQUE-ELECTRONIQUE DE LYON, Villeurbanne Cedex (FR)

(72) Inventors: Christophe BOISSON, TRAMOYES (FR); Vittoria CHIARI, Schaerbeek (BE); Gaelle PANNIER, Schaerbeek (BE); Mostafa TAOUFIK, Villeurbanne (FR)

(21) Appl. No.: 18/011,111

(22) PCT Filed: Jun. 4, 2021
(86) PCT No.: PCT/EP2021/065996

§ 371 Date: Dec. 16, 2022

(30) Foreign Application Priority Data
Jun. 18, 2020 (EP) 20180901.9
Feb. 10, 2021 (GB) 2101822.1

(51) Int. Cl. C08F 4/52; C08F 210/02; C08F 210/06

(52) U.S. Cl. CPC C08F 4/52; C08F 210/02; C08F 210/06; C08F 2410/00

(57) ABSTRACT

The present invention relates to a method for preparing a catalyst, and in particular provides a method for preparing a catalyst suitable for the polymerisation of ethylene and/or propylene, said catalyst comprising a compound of yttrium, neodymium or scandium supported on a silica support, and wherein the method comprises: a) Treating a silica support by heating at a temperature of at least 550° C., b) Contacting the treated silica support with a complex of the following formula: DₘMX¹X²R wherein M is selected from Y, Sc and Nd, R is a hydrocarbyl group, X¹ and X² are anionic groups, D is a neutral donor group, and m is 0 or greater.

The present invention relates to a method for preparing a catalyst, particularly a catalyst suitable for the polymerisation of ethylene and/or propylene, and wherein said catalyst comprises a compound of yttrium, neodymium or scandium supported on a silica support.

The polymerisation of olefins, particularly ethylene and/or propylene, is widely operated commercially, and using a number of different processes and catalysts. For example, polymerisation may be operated in reactors in the gas phase, solution phase or slurry phase. Such processes are very well known and the subject of many patent applications and literature studies.

Typically, most catalysts can be characterised into one of three main types which are widely used in the different processes, these being so-called “Phillips catalysts”, which are based on supported chromium, “Ziegler-Natta catalysts” which are most commonly based on titanium and magnesium, although some other metals can be used in place of the titanium, and “metallocene catalysts”, also often referred to as “single site catalysts”, which can be based on a number of metals, including titanium, chromium zirconium and hafnium. Again, the different types of catalyst, and many variations thereof, are the subject of many patent applications and literature studies.

It is also known that some rare-earth metal compounds can be active for polymerisation of olefins.

Woodman et al. in Macromolecules 2005, 38, 3060-3067, for example, describe the preparation of silica supported rare-earth metal catalysts based on Sc, Y, La, Nd, Sm, Gd and Dy. These catalysts are used by Woodman et al. for ethylene polymerisation reactions.

We have now found that improved polymerisation catalysts based a compound of yttrium, neodymium or scandium supported on silica are obtained if the silica is pre-treated by heating above a minimum temperature, and a compound of yttrium, neodymium or scandium containing at least one metal-C bond, is used.

Thus, in a first aspect there is provided a method for preparing a catalyst suitable for the polymerisation of ethylene and/or propylene, said catalyst comprising a compound of yttrium, neodymium or scandium supported on a silica support, and wherein the method comprises:
a) Treating a silica support by heating at a temperature of at least 550° C. to at least partially dehydroxylate the silica support but leave isolated silanol groups on the surface,
b) Contacting the treated silica support with a complex of the following formula:

DₘMX¹X²R
wherein
M is selected from Y, Sc and Nd,
R is a hydrocarbyl group or a substituted hydrocarbyl group,
X¹ and X² are anionic groups,
D is a neutral donor group, and
m is 0 or greater,
such that the complex reacts with a silanol and the metal (M) of the complex becomes bound to the surface through the formation of a M-O—Si bond.

Similarly, in a second aspect there is provided a method for preparing a catalyst suitable for the polymerisation of ethylene and/or propylene, said catalyst comprising a compound of yttrium, neodymium or scandium supported on a silica support, and wherein the method comprises:
a) Treating a silica support by heating at a temperature of at least 550° C.,
b) Contacting the treated silica support with a complex of the following formula:

DₘMX¹X²R
wherein
M is selected from Y, Sc and Nd,
R is a hydrocarbyl group or a substituted hydrocarbyl group,
X¹ and X² are anionic groups,
D is a neutral donor group, and
m is 0 or greater,
   and characterised in that the silica support is not contacted with an alumoxane prior to the treatment of step (a) or the contact with the complex of step (b).

In particular, in the present invention it has been found that the catalysts so prepared are not only active for polymerisation, but they are more active than catalysts prepared from the same complex but where the silica has not been heated, or has been heated at a lower temperature.

Further, the treatment of the silica and the use of the complex as claimed has been found to provide polymerisation activity without the necessity of adding an activator, such as aluminium or boron compounds which are commonly used, including in Woodman et al. noted above.

Without wishing to be bound by theory, this is believed due to the specific supported complex formed on the surface of the silica by the reaction of the metal complex and the heat-treated silica support.

In the second aspect, the silica support is not contacted with an alumoxane prior to the treatment of step (a) or the contact with the complex of step (b). It is also preferred in the first aspect that the silica support is not contacted with an alumoxane prior to the treatment of step (a) or the contact with the complex of step (b). Preferably, in either the first or second aspect of the present invention, the silica support is not contacted with an alumoxane or any other catalyst activator prior to the treatment of step (a) or the contact with the complex of step (b). As used herein, a “catalyst activator” is a compound which is added to a catalyst either during its preparation or during polymerisation and which can activate the catalyst so that it is catalytically active. Typical activators for particular types of catalyst are known in the art, and non-limiting examples include alumoxane compounds, modified alumoxane compounds and aluminum alkyls.

It is also preferred in either aspect that the silica support is not contacted with any compounds which may react with the treated silica between the treatment of step (a) and the contact with the complex of step (b), and more preferably also not contacted with any such compounds prior to the treatment of step (a).

Most preferably, no additional treatment steps of the silica support are performed between the treatment of step (a) and the contact with the complex of step (b).

More generally, with reference to the treatment of the silica, the silica must be heated to a temperature of at least 550° C. Preferably, the silica is heated to a temperature of at least 600° C., and more preferably at least 650° C. The silica is also preferably heated to a temperature of less than 1000° C., and preferably less than 900° C. Particular preferred temperature ranges are 600-850°, such as 650-800° C.

The heating can take place in any suitable atmosphere, including air, an inert gas, such as nitrogen, or under vacuum. The heating can take place at any suitable pressure, although either atmospheric pressure or a pressure lower than atmospheric is preferred. More preferably the heating takes place at a reduced pressure, such as 5×10⁴ Pa or less, such as 5×10³ Pa or less. Most preferably the pressure is 100 Pa or less, such as 10 Pa or less.

During the treatment the silica is preferably heated to a required treatment temperature (above 550° C., and preferably in the preferred ranges defined above) and then held at that temperature for at least 1 hours, such as 1 to 12 hours.

Generally, during the treatment of the silica support by heating at a temperature of at least 550° C. the support is partially dehydroxylated to leave isolated silanol groups on the surface. Then, on contact with the treated silica surface the metal-containing complex (the metal being yttrium, neodymium or scandium) reacts with the silanol and the metal of the complex becomes bound to the silica surface through the formation of a M-O—Si bond.

The silanol groups on the surface formed by the temperature treatment of step (a) as claimed may be considered as “isolated”. As used herein this means that they are far enough separated from each other that the complex reacts with a silanol and becomes bound to the surface through a single M-O—Si bond. Typically, the concentration of silanol groups on the surface after the temperature treatment of step (a) (and/or at the subsequent contact with the complex) is less than or equal to 2 silanol groups per square nanometre of the silica surface. The concentration of silanol groups can be measured by any suitable technique, but according to the present invention is preferably as measured by titration of the OH groups of the silanols using n-butyl lithium. (In a typical measurement, a known quantity, such as 0.5 g, of silica is contacted with a solution comprising an excess of n-butyllithium in hexane for 1 hour. The amount of butane evolved from the reaction of the butyllithium with the silanols is proportional to the number of silanols present. The butane is preferably collected and quantified by GC. Surface area is as measured before calcination by BET under ASTM D3663-03(2015), as discussed further below.)

Accordingly, less than or equal to 2 silanol groups per square nanometre corresponds to ≤2.0 OH/nm². Preferably the concentration of silanol groups is less than or equal to 1.5 OH/nm², such as less than or equal to 1.0 OH/nm². Preferably, the concentration is at least 0.5 OH/nm².

The supported metal compound should comprise at least one metal-carbon bond (again the metal being yttrium, neodymium or scandium). Again, without wishing to be bound by theory, the presence of at least one metal-carbon bond in the supported metal compound is believed to provide activity without the necessity of adding an activator in a polymerisation. When neither of X¹ and X² are hydrocarbyl groups, at least one of X¹ and X² should react preferentially with the surface (Si—O—)₃ Si—OH groups yielding a metal compound supported on the silica support containing the metal-carbon bond. For example, when X¹ or X² is hydride, the hydride bond in the metal containing complex is believed to react preferentially with the surface silanol under elimination of H₂, such that the supported metal compound retains at least one metal-carbon from the hydrocarbyl group R. Obviously, if one or both of the X groups in the metal containing complex are also hydrocarbyl groups then the supported metal compound will inevitably retain at least one metal-carbon bond. Preferably, the metal containing complex retains the R group of the initial complex DₘMX¹X²R.

Thus, the present invention also provides a method for preparing a catalyst suitable for the polymerisation of ethylene and/or propylene comprising a compound of yttrium, neodymium or scandium supported on a silica support according to the first and/or second aspects, wherein the compound of yttrium, neodymium or scandium supported on the silica support comprises the R group of the complex.

With reference to the silica itself, numerous silica materials are known for use as catalyst supports, and in particular for supported polymerisation catalysts. The initial silica material in the present invention may be chosen widely from such materials.

Typically, however, the silica before calcination may have a surface area, as measured by BET under ASTM D3663-03(2015), of 50 to 1000 m²/g, for example in the range 100 to 500 m²/g. The silica may typically have a porosity of up to 5 ml/g, such as 0.2 to 3.5 ml/g. The average particle size (D50) may typically be from 2 to 250 μm, especially 3 to 200 μm, and preferably 5 to 100 μm. The average pore diameter in the silica may typically be 20 to 1000 Angstroms, such as 50 to 800 Angstroms. Examples of suitable silica materials include Sylopol and other silicas available from Grace Davison, including Sylopol 2104, Sylopol 2109, Sylopol 2408, Sylopol 5550, Sylopol 55SJ; and silicas available form PQ Corporation, such as ES70 and ES70X, MD 747JR.

The silica support preferably is a silica support consisting essentially of silica, by which is meant that it comprises at least 99% silica by weight. However, it may in some embodiments also comprise other materials mixed therewith, for example alumina or aluminosilicate.

With reference to the complex, DₘMX¹X²R, suitable groups for X¹ and X² are those anionic groups satisfying the valency of the metal M, such as hydride, hydrocarbyl, halide, alcoholate, ester, thiolate, amide, silyl, etc.

However, in a preferred embodiment at least one of X¹ and X² is selected from hydride, hydrocarbyl and substituted hydrocarbyl groups, more preferably both of X¹ and X² are selected from hydride, hydrocarbyl and substituted hydrocarbyl groups

In one embodiment at least one of X¹ and X² is a hydride, such as both of X¹ and X² are hydride.

In a more preferred embodiment, at least one of X¹ and X² is a hydrocarbyl group or a substituted hydrocarbyl groups, and most preferably both of X¹ and X² are hydrocarbyl groups or substituted hydrocarbyl groups.

In all embodiments a hydrocarbyl or substituted hydrocarbyl group is a group that is bound to M through a metal-carbon bond.

Examples of hydrocarbyl groups are linear, branched and cyclic alkyl groups (e.g. methyl, ethyl, n-propyl, isopropyl, n-butyl, isobutyl, tert-butyl, cyclohexyl, benzyl, etc.), aryl groups (e.g. phenyl, toluyl, mesityl, etc.) and allyl groups.

Examples of substituted hydrocarbyl groups are the groups listed above but where the group contains one or more heteroatoms, i.e. an atom other than carbon or hydrogen. However, even if substituted this group remains nevertheless connected to the metal, M, by a metal-carbon bond. (For avoidance of doubt the metal-carbon/M-C bond follows from the definition of the group as a hydrocarbyl group. In contrast, if connected through a heteroatom or other substituent group then the ligand would be defined in terms of that group e.g. as an alcoholate or amide group, to give two examples.) Thus, all DₘMX¹X²R complexes in the present invention comprise at least one metal-carbon bond (where the metal is yttrium, neodymium or scandium).

In a preferred embodiment, any hydrocarbyl groups present, including R, are selected from alkyl and allyl groups and any substituted hydrocarbyl groups present, again including R, are selected from substituted alkyl and substituted allyl groups.

More preferably each of X¹, X² and R are selected from alkyl, substituted alkyl, allyl and substituted allyl groups.

In a preferred embodiment each of X¹, X² and R are the same hydrocarbyl or substituted hydrocarbyl group and most preferably each are allyl or substituted allyl groups.

Particularly preferred groups are silicon substituted allyl groups, especially trialkylsilanes, and with the most preferred group being a 1,3-C₃H₃(SiR′₃)₂ group where R′ is a linear, branched or cyclic alkyl group, such as methyl, ethyl, n-propyl, tert-butyl, cyclohexyl, etc

More generally, in the complex, DₘMX¹X²R, X¹, X² and R can be selected widely and independently within the defined requirements. For practical reasons, however, X¹, X² and R are often the same group. (And correspondingly, there will then be three M-C bonds in the initial complex, all being hydrocarbyl groups.)

In all embodiments, suitable examples of D are neutral donor groups such as linear and cyclic ethers and thioethers, amines, phosphines, aromatic heterocycles such as pyridines, etc. Typically m is from 0 to 3, such as 0, 1 or 2. Preferably, however, the complex has no donor groups D and therefore m is 0.

Most preferably, the complex DₘMX¹X²R is a monomeric complex.

Typically, the complex is added to the support in an amount that corresponds to 0.5 to 10 wt % metal, for example yttrium, compared to the mass of silica, with a range of 1 to 5 wt % being preferred.

Typically, the metal content of the supported catalyst is in the same ranges i.e. 0.5 to 10 wt % metal compared to the mass of catalyst, with a range of 1 to 5 wt % being preferred. The metal, M, is selected from yttrium, neodymium and scandium. M is preferably selected from yttrium and neodymium, with yttrium particularly preferred i.e. M is preferably Y.

In this case the complex is DₘYX¹X²R. For avoidance of doubt, where M is Y, all other features of the complex, ligands, method are nevertheless still preferably as previously defined.

The catalyst produced in the first and second aspects of the present invention is suitable for polymerisation of ethylene and/or propylene.

Thus, in a third aspect the present invention provides a catalyst suitable for the polymerisation of ethylene and/or propylene, said catalyst being prepared by the method of the first and/or second aspects.

The preferred embodiments of the catalyst are as described above e.g. typically comprising 0.5 to 10 wt % metal compared to the mass of catalyst.

In a fourth aspect, the present invention provides a process for polymerisation of ethylene or propylene, which process comprises:
(i) preparing a catalyst for the polymerisation of ethylene and/or propylene, said catalyst comprising a compound of yttrium, neodymium or scandium supported on a silica support, and wherein the method for preparing the catalyst comprises:
   a) Treating a silica support by heating at a temperature of at least 550° C.,
   b) Contacting the treated silica support with a complex of the following formula:

DₘMX¹X²R
wherein
M is selected from Y, Sc and Nd,
R is a hydrocarbyl group or a substituted hydrocarbyl group,
X¹ and X² are anionic groups,
D is a neutral donor group, and
m is 0 or greater,
   and
(ii) contacting said catalyst with ethylene or propylene, and optionally comonomers, in a polymerisation reactor,
   wherein during step (ii) alkyl aluminium or other alkylating agent is either not used or is used in an amount of less than 5 moles of alkylating agent per mole of metal (M) in the catalyst.

In a fifth aspect, which is also a preferred embodiment of the fourth aspect, the preparation of the catalyst is as described for the first and/or second aspects.

Thus, in a fifth aspect, the present invention also provides a process for polymerisation of ethylene or propylene, which process comprises:
a) preparing a catalyst according to the first aspect of the present invention and/or according to the second aspect of the present invention, and
b) polymerising ethylene or propylene by contacting said catalyst with ethylene or propylene, and optionally comonomers, in a polymerisation reactor.

In a preferred embodiment of the fifth aspect, during step (b) alkyl aluminium or other alkylating agent is either not used or is used in an amount of less than 5 moles of alkylating agent per mole of metal (yttrium, neodymium or scandium) in the catalyst.

The polymerisation process in either the fourth and fifth aspects may be performed in any suitable polymerisation reactor/under any suitable polymerisation conditions, including in a gas phase polymerisation reactor/under gas phase polymerisation conditions, a slurry phase polymerisation reactor/under slurry phase polymerisation conditions or a solution phase polymerisation reactor/under solution phase polymerisation conditions.

The preferred polymerisation processes are slurry polymerisation processes. In such processes polymerisation of a monomer, such as ethylene, takes place in an inert diluent, typically an alkane, such as isobutane, to produce a slurry of polymer particles suspended in the diluent. Typical reactors include autoclaves and slurry loop polymerisation reactors.

Typical reactors and conditions which can be used to perform the polymerisation are well-known in the art and do not need to be described here.

The polymerisation in the fourth or fifth aspect is of ethylene or propylene. Preferably, the polymerisation is a process for polymerisation of ethylene.

In general, polymerisation processes can be homopolymerisation, in which a single monomer is polymerised, or co-polymerisations, in which two or more monomers are polymerised. Also in general, and as used herein, reference to a process for polymerisation of a particular monomer, such as ethylene, refers to a process in which that monomer is either the only monomer (homopolymerisation) or is the monomer present in the largest amount in the reactor with a smaller amount of other monomer (copolymerisation). For example, “polymerisation of ethylene” refers to processes in which ethylene monomer is present in as the only monomer (ethylene homopolymerisation) or is present with other monomers, but the ethylene is present in the largest amount (ethylene copolymerisation). The monomer present in the largest amount e.g. ethylene in such a process may be referred to as the “principal” monomer. Other monomers in such reactions are referred to as comonomers.

In the present invention the process is for polymerisation of ethylene or propylene. This includes therefore
homopolymerisation of ethylene,
co-polymerisation of ethylene with a comonomer,
homopolymerisation of propylene, and
copolymerisation of propylene with a comonomer.

Preferred comonomers in the present invention, where present, are olefins other than the principal monomer, especially other C2-C10 α-olefins. For avoidance of doubt, where ethylene is the principal monomer the comonomer may be propylene and vice versa. Also, more than one comonomer may be used.

In many polymerisation processes an activating agent, such as alkyl aluminium, may be required to obtain activity, or may be useful for increasing activity.

A particular feature of the catalysts in the present invention is that they are active even without the use of an activating agent, such as aluminium alkyls. In fact, the use of an activating agent at too high a level appears to be detrimental to activity.

Preferably in either the fourth or fifth aspects, alkyl aluminium or other alkylating agent is either not used or is used in an amount of less than 1 mole of alkylating agent per mole of metal in the catalyst

The process of the fourth or fifth aspect may also include other components typically present in a polymerisation process. Hydrogen, for example, is often present as a chain transfer agent. Other components may be present depending on the process being operated—slurry processes, for example, usually take place in an inert diluent, such isobutane, whilst gas phase processes may include an inert gas, such as nitrogen in the gas phase. Such options are well-known to the person skilled in the art.

### EXAMPLES

### Catalyst Preparation

### Catalyst 1: Y Containing Catalyst, Silica Treated at 700° C.

Sylopol 2408 silica (WR Grace) was heated at 700° C. for 12 hours under a dynamic vacuum.

Y{1,3-C₃H₃(SiMe₃)₂}₃ was prepared according to the method described by White and Hanusa in Organometallics 2006, 25, p. 5621-5630.

The treated support was then contacted with Y{1,3-C₃H₃(SiMe₃)₂}₃ in hexane at room temperature. On contact the support turned rapidly yellow. After two hours the reaction was interrupted and the product dried. A bright yellow support was obtained.

The catalyst was analysed by DRIFT, which showed that all silanols on the silica surface had reacted. Based on a mass balance the composition of the catalyst is calculated as in Table 1.

TABLE 1
Elemental analysis results and olefin quantification.

| wt % | wt % | wt % | | | |
|---|---|---|---|---|---|
| Y | C | H | C/Y | H/Y | Y mmol · g⁻¹ |
| 3.7 | 8.54 | 1.6 | 17.1 | 38.1 | 0.42 |

The 8.54 wt % of carbon found on the surface corresponds to a 17.1 C/Y ratio, which is very close to the theoretical value for (≡SiO)Y{1,3-C₃H₃(SiMe₃)₂}₂, 18 C/Y. The amount of olefin C₃H₄(SiMe₃)₂ released during the grafting matches that expected for “loss” of one of the original allyl groups.

### Catalyst 2: Nd Containing Catalyst, Silica Treated at 700° C.

Sylopol 2408 silica (WR Grace) was heated at 700° C. for 12 hours under a dynamic vacuum. Nd{1,3-C₃H₃(SiMe₃)₂}₃ was prepared in an equivalent manner to the preparation of Y{1,3-C₃H₃(SiMe₃)₂}₃ but using NdCl₃.

The treated support was then contacted with Nd{1,3-C₃H₃(SiMe₃)₂}₃ in hexane at room temperature. After 24 hours the reaction the product was filtered and washed 3 times with 6 mL of toluene and 3 times with hexane (6 mL). The powder was then dried under high vacuum.

### Comparative Catalyst A: Y-Containing Catalyst, Silica Treated at 200° C.

Sylopol 2408 silica (WR Grace) was heated at 200° C. for 12 hours under a dynamic vacuum.

The treated support was then contacted with Y{1,3-C₃H₃(SiMe₃)₂}₃ in hexane at room temperature. On contact the support turned rapidly yellow. After two hours the reaction was interrupted and the product dried. A bright yellow support was obtained.

| wt % | wt % | wt % | | | |
|---|---|---|---|---|---|
| Y | C | H | C/Y | H/Y | Y mmol · g⁻¹ |
| 4.92 | 5.15 | 1.11 | 7.75 | 19.9 | 0.55 |
| | | | (th.9) | (th.21) | |

### Ethylene Polymerization

1) Small Scale Autoclave

Polymerization tests were conducted in 80 ml autoclave, with 50 ml of heptane as solvent. The reactor was pressurised with ethylene to a pressure of 10 bar. In selected experiments 1-hexene was added as comonomer. The reaction temperature was 80° C. No hydrogen was used during the polymerization.

Catalyst was injected in the reactor to initiate the reaction, and reaction was performed for 30 minutes before the reaction was stopped.

Table 1 shows the results obtained from Catalyst 1

TABLE 1

| | | | | 1- | | Activity | Activity |
|---|---|---|---|---|---|---|---|
| | mₛᵤₚₚₒᵣₜ | Y_{surface} | [TiBA] | hexene | Yield | g g_{cat}⁻¹ | Kg mol_{Y}⁻¹ |
| Run | mg | μmol | mM | mol % | g | h⁻¹ | h⁻¹ bar⁻¹ |
| 1 | 16.5 | 6.9 | — | — | 6.19 | 752 | 180 |
| 2 | 9.0 | 3.8 | — | 21 | 5.76 | 1280 | 305 |
| 3 | 11.2 | 4.7 | 1 | 21 | 4.77 | 855 | 203 |

The results from Run 1 show that the catalyst is active without the addition of TIBAL or other activating agent. The results from Run 2 show that activity is increased in the presence of 21 mol % of 1-hexene, whilst comparison of Run 3 with Run 2 shows that the addition of 1 mM of TIBAL, which is a well-known activating agent, is actually detrimental to the activity.

Table 2 shows the result obtained from Comparative Catalyst A also in the presence of TIBAL and 1-hexene:

TABLE 2

| | | | | 1- | | Activity | Activity |
|---|---|---|---|---|---|---|---|
| | mₛᵤₚₚₒᵣₜ | Y_{surface} | [TiBA] | hexene | Yield | g g_{cat}⁻¹ | Kg mol_{Y}⁻¹ |
| Run | mg | μmol | mM | mol % | g | h⁻¹ | h⁻¹ bar⁻¹ |
| 4 | 18.7 | 10.3 | 1 | 21 | 5.91 | 633 | 115 |

Comparison of Run 4 with Run 3 shows that the activity of the Comparative Catalyst A, where the silica is activated at 200° C. is much lower than that seen under the equivalent conditions for Catalyst 1, where the silica is activated at 700° C.

Table 3 shows the result obtained from Catalyst 2:

TABLE 3

| | | | | 1- | | Activity | Activity |
|---|---|---|---|---|---|---|---|
| | mₛᵤₚₚₒᵣₜ | Nd_{surface} | [TiBA] | hexene | Yield | g g_{cat}⁻¹ | Kg mol_{Y}⁻¹ |
| Run | mg | μmol | mM | mol % | g | h⁻¹ | h⁻¹ bar⁻¹ |
| 5 | 32.3 | 6.9 | 1 | 9.6 | 4.36 | 270 | 100 |
| 6 | 36.4 | 3.8 | 1 | — | 5.19 | 285 | 106 |

These results show that the Nd containing catalyst was also active for polymerisation.

2) 5 L autoclave

Polymerization tests were conducted in 5 L autoclave, with 1.5 L of isobutane as solvent. The reactor was pressurised with ethylene to a pressure of 10 bar. 2.6 mol % relative to ethylene of hydrogen was added, along with 30 g of 1-hexene as comonomer. The reactor was then heated to the reaction temperature of 80° C. The total equilibrium pressure of the system was of 24.4 bars.

100 mg of the catalyst (Catalyst 1) was injected in the reactor as a 10 wt % suspension in oil to initiate the reaction, and reaction was performed for 1 hour before the reaction was stopped.

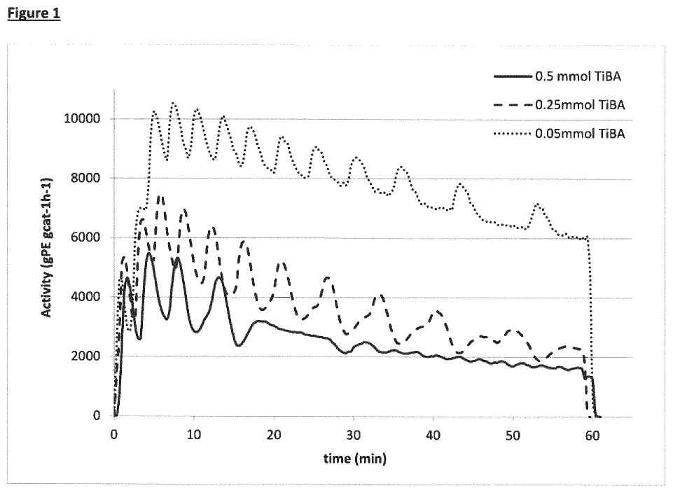

FIG. 1 shows the results obtained as a function of TIBAL addition for Catalyst 1. It can be seen that highest activity is obtained at the lowest level of TIBAL, consistent with the results shown in the small scale autoclaves.

1. A method for preparing a catalyst suitable for the polymerisation of ethylene and/or propylene, said catalyst comprising a compound of yttrium, neodymium or scandium supported on a silica support, and wherein the method comprises:
a) Treating a silica support by heating at a temperature of at least 550° C. to at least partially hydroxylate the silica support but leave silanol groups on the surface,
b) Contacting the treated silica support with a complex of the following formula:
DₘMX¹X²R
wherein
M is selected from Y, Sc and Nd,
R is a hydrocarbyl group or a substituted hydrocarbyl group,
X¹ and X² are anionic groups,
D is a neutral donor group, and
m is 0 or greater,
such that the complex reacts with a silanol and the metal (M) of the complex becomes bound to the surface through the formation of a M-O—Si bond.

2. A method for preparing a catalyst suitable for the polymerisation of ethylene and/or propylene, said catalyst comprising a compound of yttrium, neodymium or scandium supported on a silica support, and wherein the method comprises:
a) Treating a silica support by heating at a temperature of at least 550° C.,
b) Contacting the treated silica support with a complex of the following formula:
DₘMX¹X²R
wherein
M is selected from Y, Sc and Nd,
R is a hydrocarbyl group or a substituted hydrocarbyl group,
X¹ and X² are anionic groups,
D is a neutral donor group, and
m is 0 or greater,
characterised in that the silica support is not contacted with an alumoxane prior to the treatment of step (a) or the contact with the complex of step (b).

3. A method according to claim 1 wherein the silica support is not contacted with any compounds which may react with the treated silica between the treatment of step (a) and the contact with the complex of step (b), and preferably also not contacted with any such compounds prior to the treatment of step (a).

4. A method according to claim 1, wherein at least one of X¹ and X² is selected from hydride, hydrocarbyl and substituted hydrocarbyl groups.

5. A method according to claim 1, wherein both of X¹ and X² are selected from hydride, hydrocarbyl and substituted hydrocarbyl groups.

6. A method according to claim 1, wherein each of X¹, X² and R are hydrocarbyl or substituted hydrocarbyl groups.

7. A method according to claim 1 wherein at least R is an allyl or substituted allyl group, and preferably each of X¹, X² and R are allyl or substituted allyl groups.

8. A method according to claim 7 wherein the group(s) are silicon substituted allyl groups, especially trialkylsilanes.

9. A method according to claim 8 wherein the allyl group(s) are each a 1,3-C₃H₃(SiR′₃)₂ group where R′ is a linear, branched or cyclic alkyl group, such as methyl, ethyl, n-propyl, tert-butyl, cyclohexyl, etc.

10. A method according to claim 1 wherein m equals 0.

11. A method according to claim 1 wherein the metal (M) content of the supported catalyst is in range 0.5 to 10 wt % metal compared to the mass of catalyst, preferably within a range of 1 to 5 wt %.

12. A method according to claim 1 wherein the metal is yttrium (Y).

13. A catalyst suitable for the polymerisation of ethylene and/or propylene, said catalyst being prepared by the method of claim 1.

14. A process for polymerisation of ethylene or propylene, which process comprises:
(i) preparing a catalyst for the polymerisation of ethylene and/or propylene, said catalyst comprising a compound of yttrium, neodymium or scandium supported on a silica support, and wherein the method comprises:
a) Treating a silica support by heating at a temperature of at least 550° C.,
b) Contacting the treated silica support with a complex of the following formula:
DₘMX¹X²R
wherein
M is selected from Y, Sc and Nd,
R is a hydrocarbyl group or a substituted hydrocarbyl group,
X¹ and X² are anionic groups,
D is a neutral donor group, and
m is 0 or greater,
and
(ii) contacting said catalyst with ethylene or propylene, and optionally comonomers, in a polymerisation reactor,
wherein during step (ii) alkyl aluminium or other alkylating agent is either not used or is used in an amount of less than 5 moles of alkylating agent per mole of metal (M) in the catalyst.

15. A process according to claim 14 wherein the catalyst is prepared by the method of claim 1.

16. (canceled)

17. A method according to claim 2 wherein each of X¹, X² and R are hydrocarbyl or substituted hydrocarbyl groups.

18. A method according to claim 2 wherein at least R is an allyl or substituted allyl group, and preferably each of X¹, X² and R are allyl or substituted allyl groups.

19. A method according to claim 18 wherein the allyl group(s) are each a 1,3-C₃H₃(SiR′₃)₂ group where R′ is a linear, branched or cyclic alkyl group, such as methyl, ethyl, n-propyl, tert-butyl, cyclohexyl, etc.

20. A method according to claim 2 wherein the metal is yttrium (Y).

21. A process according to claim 14 wherein the catalyst is prepared by the method of claim 2.
